(19) United States
(12) Patent Application Publication
(10) Pub. No.: US 2021/0247288 A1
(43) Pub. Date: Aug. 12, 2021

(54) Particle sensor

(71) Applicant: Teknologian tutkimuskeskus VTT Oy, Espoo (FI)

(72) Inventors: Panu Koppinen, Espoo (FI); Teuvo Sillanpää, Espoo (FI); Markku Ylilammi, Espoo (FI)

(21) Appl. No.: 17/054,533

(22) PCT Filed: May 9, 2019
(86) PCT No.: PCT/FI2019/050360

§ 371 Date: Nov. 11, 2020

(30) Foreign Application Priority Data
May 11, 2018 (FI) 20185434

(51) Int. Cl. G01N 15/02; G01N 1/22; G01N 15/06

(52) U.S. Cl. CPC G01N 15/0255; G01N 2015/0046; G01N 15/0606; G01N 1/2273

(57) ABSTRACT

According to an example aspect of the present invention, there is provided an apparatus, comprising: a channel for receiving gas; thermophoretic unit configured to create a temperature gradient in the channel, and a particle detector for detecting particles in the gas on the basis of particle landing positions in the channel.

### FIELD

The present invention relates to particle detection.

### BACKGROUND

Poor air quality due to chemical and particulate pollutants is a health hazard in urban areas. According to the World Health Organization, WHO, exposure to air pollutants has contributed to seven million deaths in 2012, that being one in eight of total global deaths. In addition to the effect of air pollutants on respiratory systems of humans, strong links between exposure to air pollution and, among many other medical conditions, cardiovascular diseases and cancer have been established.

Negative health effects from airborne pollutants are manifold and depend on their composition and state, for example, gaseous or solid state. Monitoring of various air pollutants, their concentrations and space-time distribution is, therefore, important not only on the global scale, but on a finer grid within regions and localities for localization of the pollution sources and geographical extend of the pollution. In order to measure the transport of the pollutants and forecast the evolution of the pollution spread, the measurements may be conducted frequently and preferably over a dense spatial grid.

Filter-based monitoring of air pollutants comprises using filters with selectivity for particulate sizes of interest. Once the filters have been exposed to air traversing them, they may be assessed for particulate matter caught therein, to estimate concentrations of particles in the air, or, more generally, a gas.

Particulate pollutants come in a range of sizes. Smog particles may range from 0.01 to 1 micrometre, fly ash particles from 1 to 100 micrometres, pollen particles from 10 to 100 micrometres, heavy dust from 100 to 1000 micrometres and cat allergens from 0.01 to 3 micrometres, for example. Consequently, using filters, a bank of filters of differing selectivity may be used to obtain an estimate of a distribution of particle sizes of particles in the gas, such as air. The distribution of particle sizes may comprise plural estimates of particle concentrations of specific particle size, in the gas.

### SUMMARY OF THE INVENTION

According to some aspects, there is provided the subject-matter of the independent claims. Some embodiments are defined in the dependent claims.

According to a first aspect of the present invention, there is provided an apparatus, comprising: a channel for receiving gas, a thermophoretic unit configured to create a temperature gradient in the channel, and a particle detector for detecting particles in the gas on the basis of particle landing positions in the channel.

According to a second aspect of the present invention, there is provided a method, comprising: directing a thermophoretic unit of a sensor device to cause a temperature gradient in a channel of the sensor device, receiving inputs from a particle detector of the sensor device configured to detect particles of a gas sample on the basis of particle landing positions in the channel, and deriving, from the inputs, a particle concentration in the gas sample.

According to a third aspect of the present invention, there is provided an apparatus, comprising at least one processing core, at least one memory including computer program code, the at least one memory and the computer program code being configured to, with the at least one processing core, cause the apparatus at least to: direct a thermophoretic unit of a sensor device to cause a temperature gradient in a channel of the sensor device, receive inputs from a particle detector of the sensor device configured to detect particles of a gas sample on the basis of particle landing positions in the channel, and derive, from the inputs, a particle concentration in the gas sample.

According to a fourth aspect of the present invention, there is provided an apparatus, comprising means for performing the method according to the second aspect or an embodiment of the method.

According to a fifth aspect of the present invention, there is provided a computer program product configured to cause the method according to the second aspect or an embodiment of the method to be performed.

According to a sixth aspect of the present invention, there is provided a computer readable medium or a non-transitory computer readable medium comprising program instructions that, when executed by a processor, cause an apparatus to perform the method according to the second aspect or an embodiment of the method.

### BRIEF DESCRIPTION OF THE DRAWINGS

FIG. 1 illustrates an example detector apparatus;

FIGS. 2A and 2B illustrate example configurations;

FIG. 3 illustrates an example system in accordance with at least some embodiments of the present invention;

FIG. 4 comprises two plots in accordance with at least some embodiments of the present invention;

FIG. 5 is a flow graph of a method in accordance with at least some embodiments of the present invention; and

FIG. 6 illustrates an apparatus in accordance with at least some embodiments of the present invention.

### EMBODIMENTS

A sensor apparatus for fine particle detection is now provided, in which a temperature gradient is created in a channel for particle detection. A particle, when suspended in a gas possessing a temperature gradient, acquires a velocity relative to the gas in the direction of decreasing temperature. This phenomenon is known as thermophoresis. The sensor apparatus is configured to detect particles on the basis of particle landing positions in the channel.

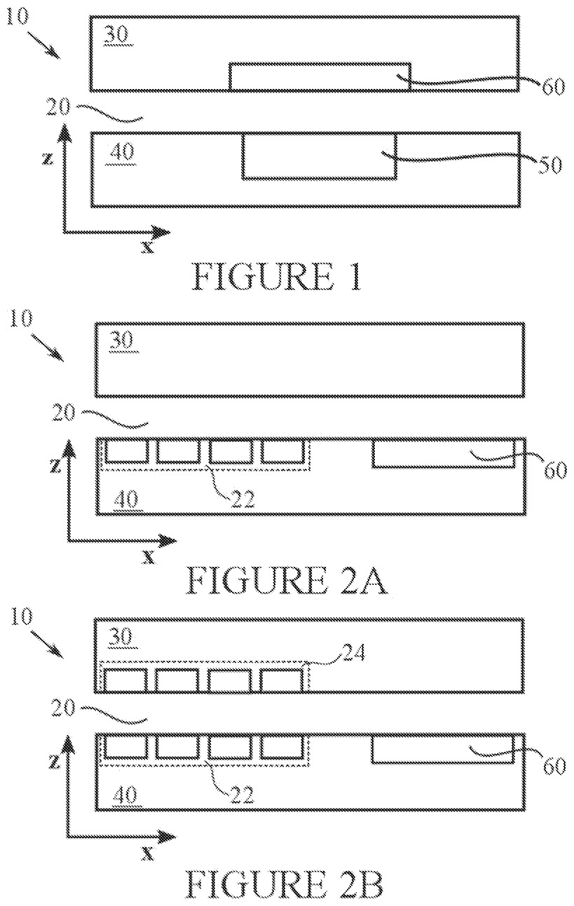

FIG. 1 illustrates a simplified example of such sensor apparatus 10. The apparatus comprises two plates 30, 40 and an air gap between the plates, forming the channel 20 for detecting particles in a gas sample. The apparatus 10 may be a microelectromechanical sensor (MEMS) device.

The sensor apparatus 10 comprises a thermophoretic unit 50 configured to create a temperature gradient in the channel. The temperature gradient drives the particles towards colder area in the channel. The thermophoretic unit 50 may be provided by a microhotplate or a microhotplate array of two or more microhotplates, for example.

A particle detector 60 may comprise a sensor or a sensor array of two or more sensors configured to detect particles on the basis of particle landing positions on the sensor or the sensor array. The term particle landing position on the sensor refers herein generally to a position or position area within a detection area of the sensor at which the particle lands (as a result of motion caused at least partly by the temperature gradient). A particle may land directly in contact with the sensor surface or there may be certain (z) distance.

The trajectory of the particles caused by the temperature gradient depends on the particle size. Thus, particles of certain size may land on certain x, z area very close to the detector 60 (in z direction) whereas particles of another size may not land at all in the detection area of the respective detector, or land at different area such that they may be differentiated. With appropriate configuration of the units 50, 60 depending on the measurement application, particles of certain size(s) of interest, which in the present disclosure may refer to certain size range(s), such as particle diameter range of 0.1-1 μm, can be detected on the basis of the detected landing positions. Hence, number of particle diameters can be measured and distribution resolved on the basis detected landing positions. A number of factors affects the landing positions and hence the applied configuration, including: positioning of the thermophoretic unit 50 and the detector 60, applied temperature distribution and resulting temperature gradient, form and dimensions of the channel 20, velocity of gas in the channel, etc.

In case of a sensor array, each sensor in the array may be configured and positioned such as to detect particles of certain size (due to such particles landing on detection area of a respective sensor). The sensors in the sensor array may be configured to provide indications of detected particles which may be sent as measurement signal for further processing. For low-cost sensor apparatuses, it may be adequate to have single sensor configured to detect particle sizes of interest, e.g. smog particles. For more detailed measurement needs number of sensors and detectors may be added, and a sensor apparatus may comprise a plurality of different detector 60-thermophoretic unit 50 configurations along the channel 20 or at different measurement channels.

In some embodiments, mass based detector(s) are applied as the detector 60. In an embodiment, the detector 60 is based on bulk acoustic wave (BAW) resonator. In some embodiments, acoustic based detector(s) are applied. The detector 60 may apply ultrasound, and in an embodiment comprises a micromachined ultrasound transducer (MUT).

In some embodiments, the detection is based on optical detection. The detector 60 may comprise optical detector(s) configured to determine the landing position of a particle on the basis of detected scattering or absorption of light beam caused by the particle.

In some embodiments, the detection is based on capacitive detection. The detector 60 may comprise a MEMS capacitor(s) and is configured to measure a capacitance of the MEMS capacitor(s). A particle flowing in the detection area of the channel 20 between plates 30, 40 of the capacitor causes a transient change in capacitance of the capacitor, which may be detected with a suitable readout circuitry. Hence, a landing position of a particle may be detected on the basis of capacitance change detected by an MEMS capacitor sensor, which may be a part of a MEMS capacitor sensor array.

FIG. 2A illustrates another example configuration for detector apparatus 10. The thermophoretic unit 50 is arranged by a microhotplate array 22 and the detector 60 is positioned on the same plate 40 as the thermophoretic unit.

FIG. 2B illustrates a further example detector configuration. Two microhotplate arrays 22, 24 are provided, enabling further improved adjustability of temperature distribution of the gas in the channel 20.

It is to be appreciated that FIGS. 1, 2A and 2B illustrate only some simple examples and various other configurations may be applied. More complicated structures may be applied and amount and positioning of the units 50, 60 may be varied in many ways. For example, one or more of the plates 30, 40 and the channel 20 may be in some another form. Another example is that the thermophoretic unit 50 is provided at one border of plate 30 and the detector 60 at another border of plate 40.

The heating power of the thermophoretic unit 50 may be fixed, or in some embodiments it may be varied. The microhotplates in the microhotplate array may be configured to provide equal heating power, or they may provide different heating power. The heating power may in some embodiments be reduced towards the detector 60 to have appropriate thermophoretic effect cooling down towards the detector so as to ensure appropriate particle landing.

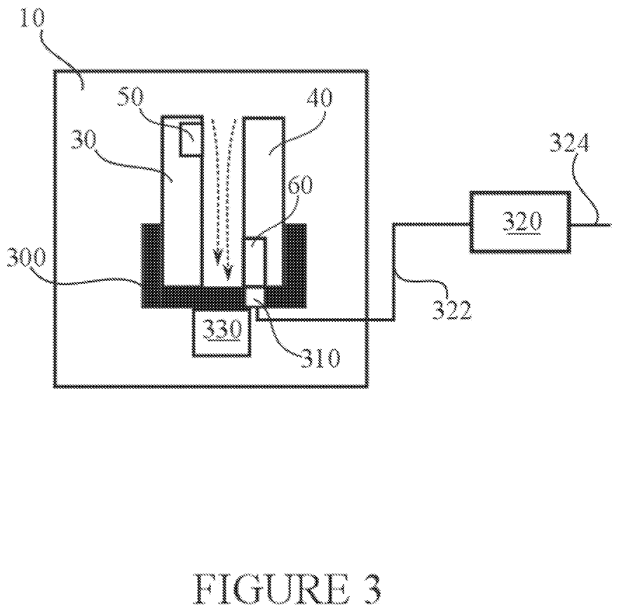

FIG. 3 illustrates an example system, comprising a sensor apparatus 10 and a control device 320 connected to the sensor apparatus 10. The sensor apparatus 10 comprises a housing 300 onto which other elements are mounted.

The particle detector 60 comprises an output 310 for providing a signal for the control device 320 via an operative connection 322. The output 310 may comprise readout circuitry to provide the signal from the detector to the control device 320. The signal may be indicative of detected particle landing positions. Depending on the applied detector type, it is to be appreciated that the signal of output 310 may indicate further information derived on the basis of the detected particle landing positions, such as indicate particle sizes and amount of detected particles determined on the basis of detected particle landing positions.

In an example embodiment, the output 310 may comprise a readout circuitry configured to measure the capacitance of MEMS capacitor 100 by determining its response to a square wave, or by a resonance measurement, for example, as is known in the art.

The control device 320 may be configured to record measurement signals from the output 310 via the connection 322. The connection 324 may connect the control device 320 to further nodes, for example via the Internet, Internet of Things or a sensor network. The connection 324 may be wire-line or at least in part wireless. It is to be appreciated that multiple sensor apparatuses 10 may be connected to the control device 320, and/or a sensor apparatus may comprise the control device 320.

In some embodiments, a further gas conveyor 330 is provided in the sensor apparatus 10, configured to cause gas to flow between plates 30, 40. For example, gas conveyor may be arranged to generate a pressure gradient across the length of the channel 20. A pressure gradient may be generated by a fan installed to create under-pressure between the gas conveyor 330 and the channel, as illustrated in FIG. 3, and/or to create over-pressure between the gas conveyor and the channel.

The gas conveyor 330 may be configured to provide a continuous gas flow in the channel, enabling continuous measurement. The power of the gas conveyor 330 may be adapted, e.g. to empty the channel 20 of landed particles with increased flow.

In another embodiment, the gas conveyor 330 may be switched on when providing a gas sample to the channel and switched of during the measurement. The control device 320 may control also the gas conveyor.

In some embodiments, the width of the channel 20 (in z direction) is adjustable. Plate 40 may be mounted on housing 300 using a spring mounting, for example, such that the distance between plates 30 and 40 is adjustable, for example by applying a selectable bias voltage to the plates to thereby generate an electrostatic attractive force of selectable strength. The control device 320 may be configured to cause the channel width between the plates 30, 40 to change, for example by causing the bias voltage to change. Many mechanical variations of the spring mechanism may be employed, or, additionally or alternatively, other ways to enable adjusting the distance between plates 30 and 40.

Existing fine particle detection schemes are typically bulky, that is not portable, and expensive, tens of thousands of euros, while on-chip solutions have several advantages over existing solutions, such as small size, low cost and low power consumption. The present features facilitate a miniaturized particle sensor platform, which is a key enabler for sensor networks for air quality monitoring that can be formed either by embedding sensors in basic infrastructure or even in mobile devices. The air quality data, possibly together with pressure information, can be collected to the cloud service, and utilized for air quality forecasting. The forecasting enables an early warning system for the air pollution levels. Also, a mobile fine particle sensor would work as a personal dosimeter to measure accumulated exposure to the fine particle hazards. Such a sensor network has a significant societal and economic impact, due to reduction in mortality rates and healthcare costs.

In use, the gas conveyor 330 may push or pull gas, such as air, through the channel 20 between the plates 30 and 40. The thermophoretic unit 50 causes the temperature gradient in the channel 20. In case a particle is conveyed into the channel, the temperature gradient causes the particle to move to a landing position in relation to the particle size. The particle detector 60 or the control device 320 may be configured to assign an estimated size to the particle, based on the detected landing position of the particle. The height of the channel (in z direction) defines an upper limit for a diameter of a particle passing through. A mapping may be prepared from the landing position to an estimate of particle size. The mapping may be prepared, before measurements are conducted, experimentally or from first principles.

To determine a concentration of particles, the control device 320 may have an estimate of how much gas passes through the channel. This may be known beforehand, using a table of gas flow rates, using gas conveyor 330, as a function of the channel height.

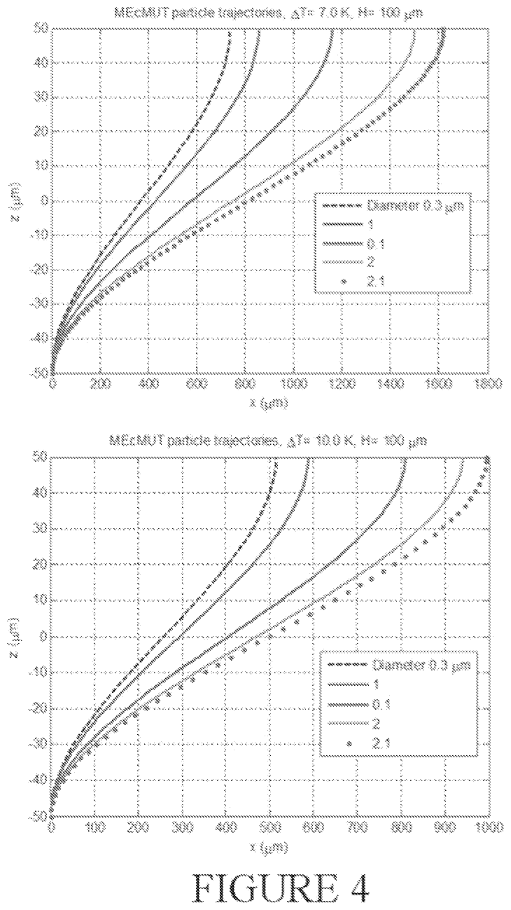

FIG. 4 comprises two example plots of particle trajectories in x and z directions in a configuration as illustrated in FIG. 1. In the upper plot, particle trajectories for particle diameters 0.3 μm, 1 μm, 0.1 μm, 2 μm and 2.1 μm are illustrated when the temperature difference is 7 K over a 0.1 mm channel height H (in z direction). The lower plot illustrates particle trajectories when the temperature difference is 10 K over a 0.1 mm channel height H. The starting point of the particles is the lower (hot) edge (z=−50 μm) of the channel. If the detector is 1 mm long particles larger than 2.1 μm cannot traverse the whole channel before they drift beyond the detector surface when ΔT=10 K. Therefore the response gradually decreases when the particle size increases above this diameter.

It is to be noted that the results in FIG. 4 are approximate because some temperature gradient exists already before x=0 and the gas flow may affect the temperature distribution and vice versa. Also, diffusion is neglected.

A numerical example is provided for MUT: Given channel height H (in x direction), channel width W (in z direction), and gas velocity v, volume flow is

dV/dt=HWv.

In the present example, the following applies:

Efficiency of particle collection β=0.9,

Relative sensitivity of the MUT detector in S=5 μg−1,

Relative resolution of frequency determination Δflf=1 ppm,

Measurement time t=30 s,

Channel height H=0.1 mm,

Channel width W=1 mm, and

Air flow velocity v=1 cm/s.

Resolution of particle concentration is:

$$Δ m = \frac{Δ f / f}{S β HWvt} = 7.4 \frac{μ g}{{m}^{3}}$$

This is enough for differentiating between good (m<25 μg/m3) and poor air quality.

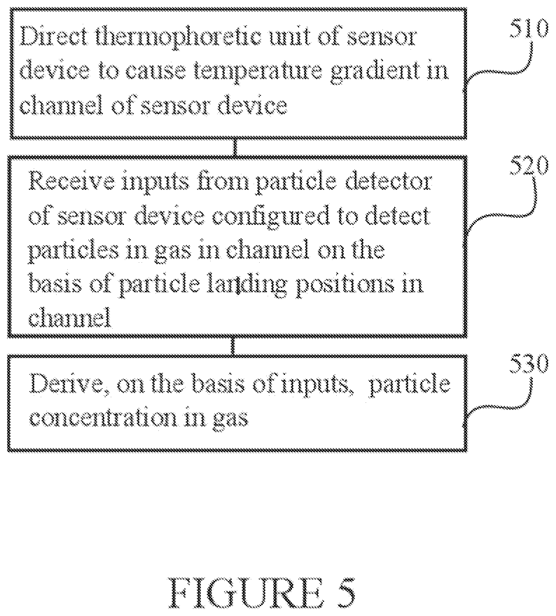

FIG. 5 is a flow graph of a method in accordance with at least some embodiments. The phases of the illustrated method may be performed in the control device 320, the sensor apparatus 10 comprising control functionality, an auxiliary device or a personal computer, for example, or in a control device configured to control the functioning thereof, when installed therein.

Phase 510 comprises directing a thermophoretic unit of a sensor device to cause a temperature gradient in a channel of the sensor device. Phase 520 comprises receiving inputs from a particle detector of the sensor device configured to detect particles of a gas sample on the basis of particle landing positions in the channel. Phase 530 comprises deriving, from the inputs, a particle concentration in the gas sample.

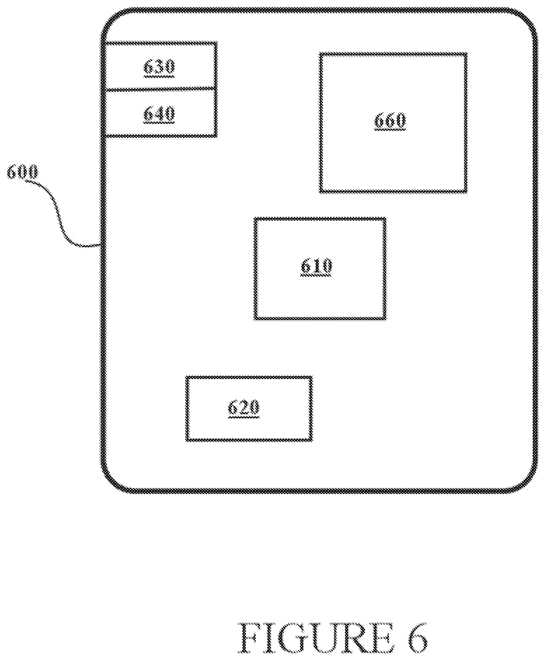

FIG. 6 illustrates an example apparatus capable of supporting at least some embodiments of the present invention. Illustrated is device 600, which may comprise, for example, the control device 320 of FIG. 3. Comprised in device 600 is processor 610, which may comprise, for example, a single- or multi-core processor wherein a single-core processor comprises one processing core and a multi-core processor comprises more than one processing core. Processor 610 may comprise, in general, a control device. Processor 610 may comprise more than one processor. Processor 610 may be a control device. Processor 610 may comprise at least one application-specific integrated circuit, ASIC. Processor 610 may comprise at least one field-programmable gate array, FPGA. Processor 610 may be means for performing method steps in device 600. Processor 610 may be configured, at least in part by computer instructions, to perform actions.

Device 600 may comprise memory 620. Memory 620 may comprise random-access memory and/or permanent memory. Memory 620 may comprise at least one RAM chip. Memory 620 may comprise solid-state, magnetic, optical and/or holographic memory, for example. Memory 620 may be at least in part accessible to processor 610. Memory 620 may be at least in part comprised in processor 610. Memory 620 may be means for storing information. Memory 620 may comprise computer instructions that processor 610 is configured to execute. When computer instructions configured to cause processor 610 to perform certain actions are stored in memory 620, and device 600 overall is configured to run under the direction of processor 610 using computer instructions from memory 620, processor 610 and/or its at least one processing core may be considered to be configured to perform said certain actions. Memory 620 may be at least in part comprised in processor 610. Memory 620 may be at least in part external to device 600 but accessible to device 600.

Device 600 may comprise a transmitter 630. Device 600 may comprise a receiver 640. Transmitter 630 and receiver 640 may be configured to transmit and receive, respectively, information in accordance with at least one cellular or non-cellular standard. Transmitter 630 may comprise more than one transmitter. Receiver 640 may comprise more than one receiver. Transmitter 630 and/or receiver 640 may be configured to operate in accordance with global system for mobile communication, GSM, wideband code division multiple access, WCDMA, 5G, long term evolution, LTE, IS-95, wireless local area network, WLAN, and/or Ethernet standards, for example.

Device 600 may comprise user interface, UI, 660. UI 660 may comprise at least one of a display, a keyboard, a touchscreen, a vibrator arranged to signal to a user by causing device 600 to vibrate, a speaker and a microphone. A user may be able to operate device 600 via UI 660, for example to configure particle detection measurements.

Processor 610 may be furnished with a transmitter arranged to output information from processor 610, via electrical leads internal to device 600, to other devices comprised in device 600. Such a transmitter may comprise a serial bus transmitter arranged to, for example, output information via at least one electrical lead to memory 620 for storage therein. Alternatively to a serial bus, the transmitter may comprise a parallel bus transmitter. Likewise processor 610 may comprise a receiver arranged to receive information in processor 610, via electrical leads internal to device 600, from other devices comprised in device 600. Such a receiver may comprise a serial bus receiver arranged to, for example, receive information via at least one electrical lead from receiver 640 for processing in processor 610. Alternatively to a serial bus, the receiver may comprise a parallel bus receiver.

Device 600 may comprise further units not illustrated in FIG. 6. For example, where device 600 comprises a smartphone, it may comprise at least one digital camera. Device 600 may comprise a fingerprint sensor arranged to authenticate, at least in part, a user of device 600. In some embodiments, device 600 lacks at least one unit described above.

Processor 610, memory 620, transmitter 630, receiver 640 and/or UI 660 may be interconnected by electrical leads internal to device 600 in a multitude of different ways. For example, each of the aforementioned devices may be separately connected to a master bus internal to device 600, to allow for the devices to exchange information. However, as the skilled person will appreciate, this is only one example and depending on the embodiment various ways of interconnecting at least two of the aforementioned devices may be selected without departing from the scope of the present invention.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in particle detection.

### ACRONYMS LIST

BAW Bulk acoustic wave
GSM Global system for mobile communication
LTE Long term evolution
MEMS Microelectromechanical sensor
MUT Micromachined ultrasound transducer
WCMA Wideband code division multiple access
WLAN Wireless local area network

1. An apparatus comprising:
a channel for receiving gas,
a thermophoretic unit configured to create a temperature gradient in the channel, and
a particle detector configured to detect particles in the gas on the basis of particle landing positions in the channel.

2. The apparatus according to claim 1, wherein the thermophoretic unit comprises a microhotplate or an array of microhotplates.

3. The apparatus according to claim 1, wherein the particle detector comprises a sensor or a sensor array configured to detect particles on the basis of particle landing positions on the sensor or the sensor array.

4. The apparatus according to claim 3, wherein the particle detector comprises a sensor array configured such that particle detection by a sensor in the sensor array is indicative of a predefined particle size.

5. The apparatus according to claim 1, wherein the particle detector comprises an output for providing a signal indicative of detected particle landing positions and amount of particles detected.

6. The apparatus according to claim 1, wherein the apparatus further comprises a mechanism to create a pressure difference over the channel.

7. An apparatus comprising at least one processing core and at least one memory including computer program code; the at least one memory and the computer program code being configured to, with the at least one processing core, cause the apparatus at least to:
direct a thermophoretic unit of a sensor device to cause a temperature gradient in a channel of the sensor device,
receive inputs from a particle detector of the sensor device configured to detect particles of a gas sample on the basis of particle landing positions in the channel, and
derive, from the inputs, a particle concentration in the gas sample.

8. The apparatus according to claim 7, wherein the apparatus is configured to receive the inputs as a signal indicative of detected particle landing positions and amount of particles detected.

9. The apparatus according to claim 7, wherein the particle detector comprises a sensor array, the apparatus is configured to receive an indication of at least one particle-detecting sensor of the sensor array, and the apparatus is configured to define particle size on the basis of the indication.

10. A method, comprising:
directing a thermophoretic unit of a sensor device to cause a temperature gradient in a channel of the sensor device,
receiving inputs from a particle detector of the sensor device configured to detect particles of a gas sample on the basis of particle landing positions in the channel, and
deriving, from the inputs, a particle concentration in the gas sample.

11. The method according to claim 10, wherein the thermophoretic unit comprises a microhotplate or an array of microhotplates.

12. The method according to claim 10, wherein the inputs are received as a signal indicative of detected particle landing positions and amount of particles detected.

13. The method according to claim 10, wherein the particle detector comprises a sensor array, the apparatus is configured to receive an indication of at least one particle-detecting sensor of the sensor array, and particle size is defined on the basis of the indication.

14. (canceled)

15. A non-transitory computer readable medium comprising computer program instructions that, when executed by a processor, cause an apparatus at least to perform a method in accordance with claim 10.

16. The apparatus according to claim 2, wherein the particle detector comprises a sensor or a sensor array configured to detect particles on the basis of particle landing positions on the sensor or the sensor array.

17. The apparatus according to claim 2, wherein the apparatus further comprises a mechanism to create a pressure difference over the channel.

18. The apparatus according to claim 8, wherein the particle detector comprises a sensor array, the apparatus is configured to receive an indication of at least one particle-detecting sensor of the sensor array, and the apparatus is configured to define particle size on the basis of the indication.

19. The method according to claim 11, wherein the inputs are received as a signal indicative of detected particle landing positions and amount of particles detected.

20. The method according to claim 11, wherein the particle detector comprises a sensor array, the apparatus is configured to receive an indication of at least one particle-detecting sensor of the sensor array, and particle size is defined on the basis of the indication.
